(19) United States
(12) Patent Application Publication
(10) Pub. No.: US 2024/0388717 A1
(43) Pub. Date: Nov. 21, 2024

(54) VIDEO ENCODING APPARATUS FOR PERFORMING VIDEO COMPRESSION WITH AID OF CONTENT ACTIVITY ANALYSIS AND ASSOCIATED VIDEO ENCODING METHOD

(71) Applicant: MEDIATEK INC., Hsin-Chu (TW)

(72) Inventors: Chin-Jung Yang, Hsinchu City (TW); Chun-Kai Huang, Hsinchu City (TW); Ping-Han Lee, Hsinchu City (TW); Tzu-Yun Tseng, Hsinchu City (TW); Tung-Hsing Wu, HsinchuCity (TW)

(73) Assignee: MEDIATEK INC., Hsin-Chu (TW)

(21) Appl. No.: 18/784,857

(22) Filed: Jul. 25, 2024

Related U.S. Application Data
(63) Continuation-in-part of application No. 17/892,139, filed on Aug. 22, 2022.
(60) Provisional application No. 63/296,172, filed on Jan. 4, 2022.

(51) Int. Cl. H04N 19/14; H04N 19/12; H04N 19/172; H04N 19/70; H04N 19/85

(52) U.S. Cl. CPC H04N 19/14; H04N 19/12; H04N 19/172; H04N 19/70; H04N 19/85

(57) ABSTRACT

A video encoding apparatus includes a content activity analyzer circuit and a video encoder circuit. The content activity analyzer circuit applies a content activity analysis process to a plurality of frames, and generate a plurality of content activity analysis results, wherein the plurality of frames are derived from a plurality of input frames of the video encoding apparatus. The video encoder circuit performs a video encoding process to generate a bitstream output of the video encoding apparatus. At least one frame is not encoded into the bitstream output according to the plurality of content activity analysis results.

### CROSS REFERENCE TO RELATED APPLICATION

This application is a continuation-in-part of U.S. Application Ser. No. 17/892,139, filed on Aug. 22, 2022, which claims the benefit of U.S. Provisional Application No. 63/296,172, filed on Jan. 4, 2022. The contents of these applications are incorporated herein by reference.

### BACKGROUND

The present invention relates to video compression, and more particularly, to a video encoding apparatus for performing video compression (e.g. low bit-rate video compression) with the aid of content activity analysis and an associated video encoding method.

One of the recent targets in mobile telecommunications is to increase the speed of data transmission to enable incorporation of multimedia services to mobile networks. One of the key components of multimedia is digital video. Transmission of digital video includes a continuous traffic of data. In general, the amount of data needed by digital video is high compared with many other types of media. Thus, there is a need for an innovative method and apparatus for low bit-rate video compression.

### SUMMARY

One of the objectives of the claimed invention is to provide a video encoding apparatus for performing video compression (e.g. low bit-rate video compression) with the aid of content activity analysis and an associated video encoding method.

According to a first aspect of the present invention, an exemplary video encoding apparatus is disclosed. The exemplary video encoding apparatus includes a content activity analyzer circuit and a video encoder circuit. The content activity analyzer circuit is arranged to apply a content activity analysis process to a plurality of frames, and generate a plurality of content activity analysis results, wherein the plurality of frames are derived from a plurality of input frames of the video encoding apparatus. The video encoder circuit is arranged to perform a video encoding process to generate a bitstream output of the video encoding apparatus. At least one frame is not encoded into the bitstream output according to the plurality of content activity analysis results.

According to a second aspect of the present invention, an exemplary video encoding method is disclosed. The exemplary video encoding method includes: applying a content activity analysis process to a plurality of frames, and generating a plurality of content activity analysis results, wherein the plurality of frames are derived from a plurality of input frames; and performing a video encoding process to generate a bitstream output. At least one frame is not encoded into the bitstream output according to the plurality of content activity analysis results.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a first video encoding apparatus according to an embodiment of the present invention.

FIG. 2 is a diagram illustrating a content activity analysis process according to an embodiment of the present invention.

FIG. 3 is a diagram illustrating a second video encoding apparatus according to an embodiment of the present invention.

FIG. 4 is a diagram illustrating 2-mode activity indication derived from consecutive frames (e.g. two input frames, or one input frame and one processed frame) according to an embodiment of the present invention.

FIG. 5 is a diagram illustrating 3-mode activity indication derived from consecutive frames (e.g. two input frames, or one input frame and one processed frame) according to an embodiment of the present invention.

FIG. 6 is a diagram illustrating a third video encoding apparatus according to an embodiment of the present invention.

FIG. 7 is a diagram illustrating a fourth video encoding apparatus according to an embodiment of the present invention.

FIG. 8 is a diagram illustrating a post-transform content activity analysis process according to an embodiment of the present invention.

FIG. 9 is a diagram illustrating a fifth video encoding apparatus according to an embodiment of the present invention.

FIG. 10 is a diagram illustrating 2-mode activity indication derived from consecutive frames (e.g. two transformed frames, or one transformed frame and one processed transformed frame) according to an embodiment of the present invention.

FIG. 11 is a diagram illustrating 3-mode activity indication derived from consecutive frames (e.g. transformed frames, or one transformed frame and one processed transformed frame) according to an embodiment of the present invention.

FIG. 12 is a diagram illustrating a sixth video encoding apparatus according to an embodiment of the present invention.

FIG. 13 is a diagram illustrating a seventh video encoding apparatus according to an embodiment of the present invention.

FIG. 14 is a diagram illustrating an eighth video encoding apparatus according to an embodiment of the present invention.

FIG. 15 is a diagram illustrating a ninth video encoding apparatus according to an embodiment of the present invention.

FIG. 16 is a diagram illustrating a tenth video encoding apparatus according to an embodiment of the present invention.

FIG. 17 is a diagram illustrating a content activity analyzer circuit with a skip-frame function according to an embodiment of the present invention.

FIG. 18 is a diagram illustrating a video encoder circuit with a skip-frame function according to an embodiment of the present invention.

FIG. 19 is a diagram illustrating an encode-policy-aided video encoder circuit according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

FIG. 1 is a diagram illustrating a first video encoding apparatus according to an embodiment of the present invention. The video encoding apparatus 100 includes a content activity analyzer circuit (labeled by “content activity analyzer”) 102 and a video encoder circuit (labeled by “video encoder”) 104. The content activity analyzer circuit 102 is arranged to apply a content activity analysis process to consecutive frames, to generate content activity analysis results. In this embodiment, the consecutive frames received by the content activity analyzer circuit 102 are input frames 101 of the video encoding apparatus 100, and the content activity analysis results generated by the content activity analyzer circuit 102 are processed frames 103. It should be noted that, in accordance with the proposed content activity analysis process, a previous processed frame 103 generated for a previous input frame 101 may be referenced by the content activity analyzer circuit 102 for content activity analysis of a current input frame 101.

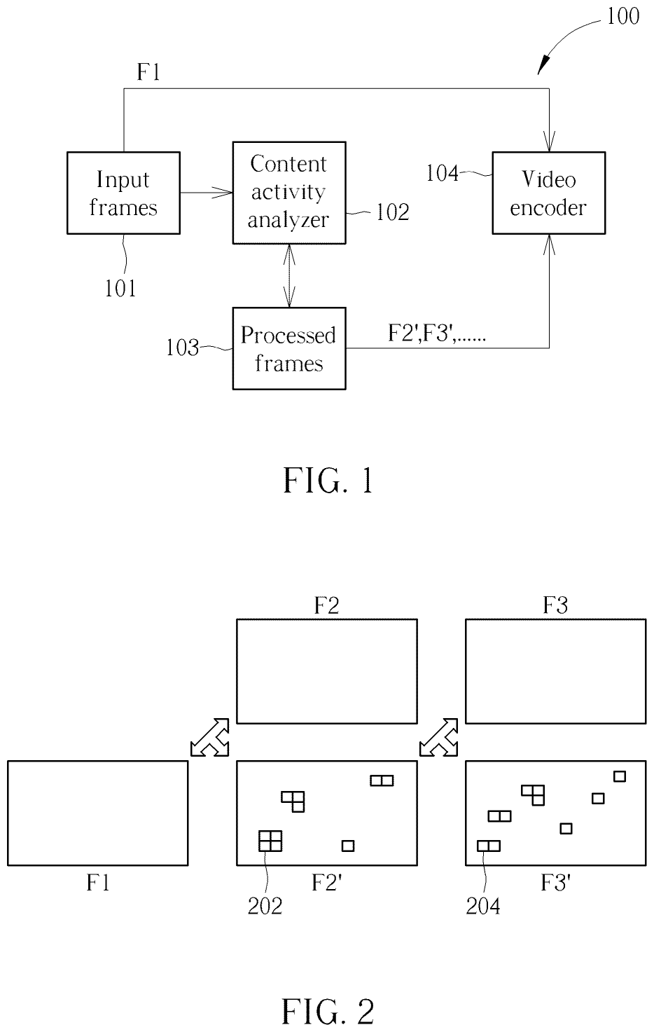

FIG. 2 is a diagram illustrating a content activity analysis process according to an embodiment of the present invention. The input frames 101 include consecutive frames such as frames F1, F2, and F3. The content activity analyzer circuit 102 derives a processed frame F2′ from the input frames F1 and F2. Specifically, the content activity analyzer circuit 102 performs content activity analysis of pixel data of input frames F1 and F2 to identify static pixel data in the input frame F2, where the static pixel data means that there is no motion activity between a current frame (i.e. input frame F2) and a previous frame (i.e. input frame F1). In addition, the content activity analyzer circuit 102 derives processed pixel data 202, and generates the processed frame F2′ by replacing the static pixel data identified in the input frame F2 with the processed pixel data 202. For example, the processed pixel data 202 is static pixel data in the input frame F1. For another example, the processed static pixel data 202 is generated by applying an arithmetic operation to pixel data in the input frames F1 and F2. With the help of the processed pixel data 202 in the processed frame F2′, the complexity of encoding the processed frame F2′ can be reduced, resulting in a low bit-rate bitstream.

The processed frame F2′ is distinct from the input frame F2, and may be used as a substitute of the input frame F2 for following content activity analysis. Compared to content activity analysis of pixel data of input frames F3 and F2, content activity analysis of pixel data of input frame F3 and processed frame F2′ can produce a more accurate static pixel data detection result. As shown in FIG. 2, the content activity analyzer circuit 102 derives a processed frame F3′ from the input frame F3 and the processed frame F2′. Specifically, the content activity analyzer circuit 102 performs content activity analysis of pixel data of input frame F3 and processed frame F2′ to identify static pixel data in the input frame F3, where the static pixel data means that there is no motion activity between a current frame (i.e. input frame F3) and a previous frame (i.e. processed frame F2′). In addition, the content activity analyzer circuit 102 derives processed pixel data 204, and generates the processed frame F3′ by replacing the static pixel data identified in the input frame F3 with the processed pixel data 204. For example, the processed pixel data 204 is static pixel data in the processed frame F2′. For another example, the processed static pixel data 204 is generated by applying an arithmetic operation to pixel data in the input frame F3 and processed frame F2′. With the help of the processed pixel data 204 in the processed frame F3′, the complexity of encoding the processed frame F3′ can be reduced, resulting in a low bit-rate bitstream. Similarly, the processed frame F3′ is distinct from the input frame F3, and may be used as a substitute of the input frame F3 for following content activity analysis. Similar description is omitted here for brevity.

The video encoder circuit 104 is arranged to perform a video encoding process to generate a bitstream output of the video encoding apparatus 100, wherein information derived from the content activity analysis results (e.g. processed frames 103) is referenced by the video encoding process. In this embodiment, the video encoder circuit 104 encodes the input frame F1 to generate a first frame bitstream included in the bitstream output, encodes the processed frame F2′ to generate a second frame bitstream included in the bitstream output, encodes the processed frame F3′ to generate a third frame bitstream included in the bitstream output, and so forth. It should be noted that the video encoder circuit 104 may be implemented by any suitable encoder architecture. That is, the present invention has no limitations on the encoder architecture employed by the video encoder circuit 104.

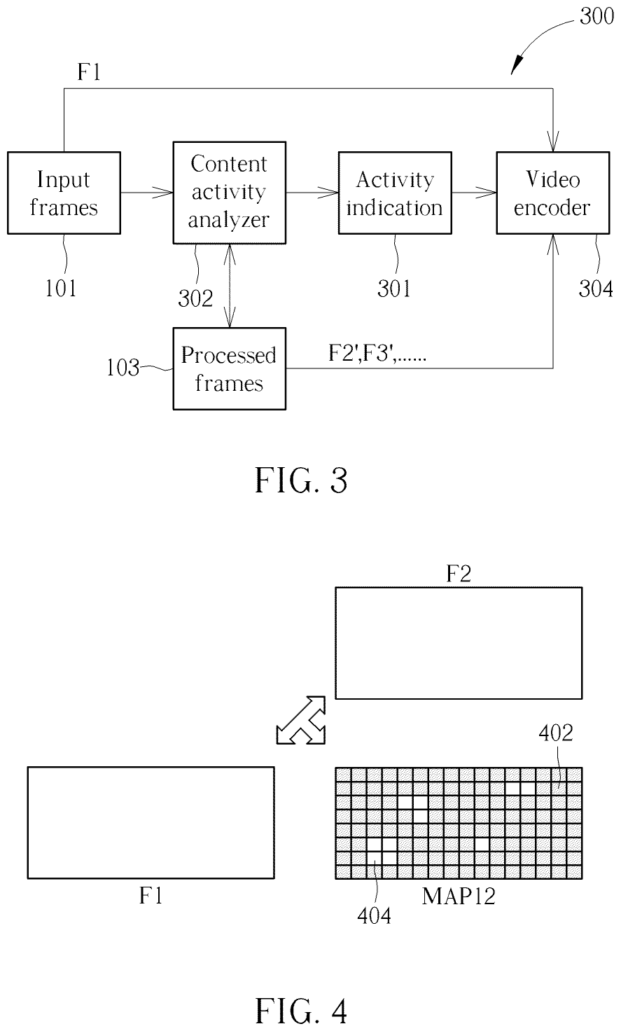

FIG. 3 is a diagram illustrating a second video encoding apparatus according to an embodiment of the present invention. The video encoding apparatus 300 includes a content activity analyzer circuit (labeled by “content activity analyzer”) 302 and a video encoder circuit (labeled by “video encoder”) 304. Like the content activity analyzer circuit 102, the content activity analyzer circuit 302 is arranged to apply a content activity analysis process to consecutive frames, to generate content activity analysis results. In this embodiment, the consecutive frames received by the content activity analyzer circuit 302 are input frames 101 of the video encoding apparatus 300. The difference between the content activity analyzer circuits 302 and 102 is that the content activity analysis results generated by the content activity analyzer circuit 302 include processed frames 103 and activity indication 301. Since the principles of generating the processed frames 103 are described above with reference to FIG. 2, further description is omitted here for brevity. In some embodiments of the present invention, the activity indication 301 may be generated after the processed frames 103 are derived from content activity analysis of the input frames 101. The generation of the activity indication 301 depends on the content activity analysis applied to the input frames 101. In other words, the activity indication 301 may be a byproduct of the content activity analysis process performed by the content activity analyzer circuit 302. For example, the activity indication 301 may include a plurality of activity indication maps, each recording one activity indication for each of a plurality of blocks of pixels.

FIG. 4 is a diagram illustrating 2-mode activity indication derived from consecutive frames (e.g. two input frames, or one input frame and one processed frame) according to an embodiment of the present invention. As shown in FIG. 4, the content activity analyzer circuit 302 may perform content activity analysis of pixel data in the input frames F1 and F2 to generate an activity indication map MAP12 that is a 2-mode activity indication map including static pixel data indication 402 and non-static pixel data indication 404, where each static pixel data indication 402 means no motion activity between co-located blocks in input frames F1 and F2, and the non-static pixel data indication 404 means motion activity between co-located blocks in input frames F1 and F2. Alternatively, the input frames F1 and F2 shown in FIG. 4 may be replaced with an input frame (e.g. F3) and a processed frame (e.g. F2′), such that a 2-mode activity indication map is derived from content activity analysis of pixel data in the input frame and the processed frame. Since a block-based video encoding process is employed by the video encoder circuit 304, the activity indication 301 generated from the content activity analyzer circuit 302 may be block-based activity indication. For example, each static pixel data indication 402 represented by one square in FIG. 4 may indicate static activity of a block of pixels, and each non-static pixel data indication 404 represented by one square in FIG. 4 may indicate motion (non-static) activity of a block of pixels.

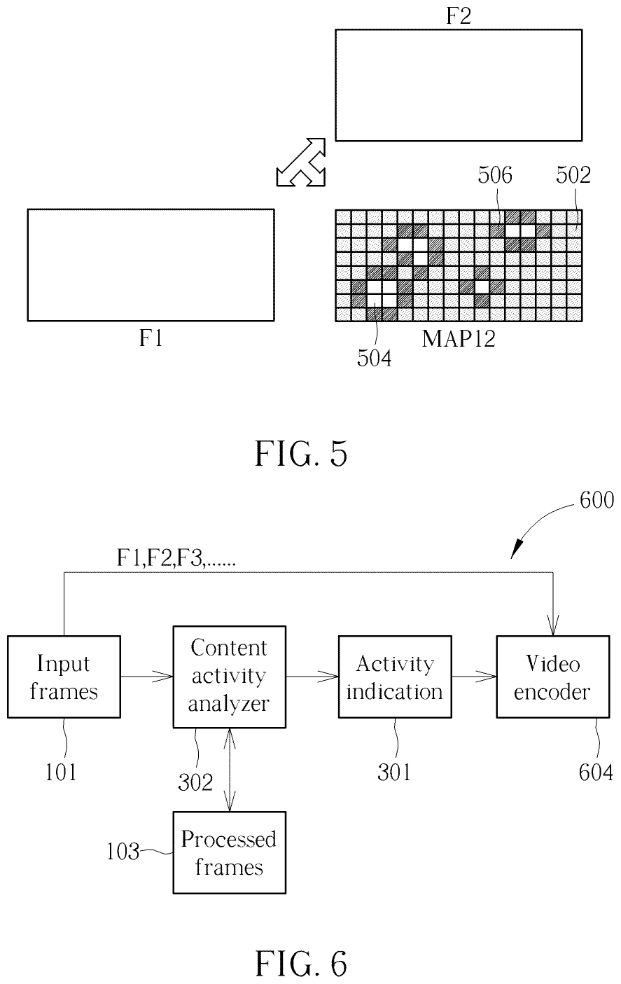

FIG. 5 is a diagram illustrating 3-mode activity indication derived from consecutive frames (e.g. two input frames, or one input frame and one processed frame) according to an embodiment of the present invention. As shown in FIG. 5, the content activity analyzer circuit 302 may perform content activity analysis of pixel data in the input frames F1 and F2 to generate an activity indication map MAP12 that is a 3-mode activity indication map including static pixel data indication 502, non-static pixel data indication 504, and contour of motion (or static) pixel data indication 506, where the static pixel data indication 502 means no motion activity between co-located blocks in input frames F1 and F2, the non-static pixel data indication 504 means motion activity between co-located blocks in input frames F1 and F2, and the contour of motion (or static) pixel data indication 506 means the contour of motion activity between input frames F1 and F2. It should be noted that the contour of motion (or static) pixel data indication 506 may be regarded as a guard ring between motion pixel data (non-static pixel data) and static pixel data. Hence, the terms “contour of motion pixel data indication” and “contour of static pixel data indication” may be interchangeable.

Alternatively, the input frames F1 and F2 shown in FIG. 5 may be replaced with an input frame (e.g. F3) and a processed frame (e.g. F2′), such that a 3-mode activity indication map is derived from content activity analysis of pixel data in the input frame and the processed frame. Since a block-based video encoding process is employed by the video encoder circuit 304, the activity indication 301 generated from the content activity analyzer circuit 302 may be block-based activity indication. For example, each static pixel data indication 502 represented by one square in FIG. 5 may indicate static activity of a block of pixels, each non-static pixel data indication 504 represented by one square in FIG. 5 may indicate motion (non-static) activity of a block of pixels, and each contour of motion (or static) pixel data indication 506 represented by one square may correspond to a block of pixels at the boundary between motion pixel data (non-static pixel data) and static pixel data.

The video encoder circuit 304 is arranged to perform a video encoding process to generate a bitstream output of the video encoding apparatus 300, wherein information derived from the content activity analysis results (e.g. processed frames 103 and activity indication 301) is referenced by the video encoding process. In this embodiment, the video encoder circuit 304 encodes the input frame F1 to generate a first frame bitstream included in the bitstream output, encodes the processed frame F2′ according to the activity indication 301 (particularly, activity indication map derived from input frames F2 and F1), to generate a second frame bitstream included in the bitstream output, encodes the processed frame F3′ according to the activity indication 301 (particularly, activity indication map derived from input frame F3 and processed frame F2′), to generate a third frame bitstream included in the bitstream output, and so forth.

Regarding 2-mode activity indication, it will give two different instructions to the video encoder circuit 304. For example, a plurality of 2-mode activity indication maps are associated with the processed frames 103, respectively. That is, a 2-mode activity indication map associated with a current processed frame to be encoded by the video encoder 304 is referenced by the video encoder 304 to determine how to encode each coding unit (coding block) within the current processed frame. When a coding unit (coding block) in a current processed frame to be encoded is found being associated with the non-static pixel data indication 404 recorded in a 2-mode activity indication map, the video encoder circuit 304 may encode the coding unit (coding block) in a typical manner as specified by a coding standard. When a coding unit (coding block) in a current processed frame to be encoded is found being associated with the static pixel data indication 402 recorded in the 2-mode activity indication map, the video encoder circuit 304 may force a coded motion vector of the coding unit to zero, or may encode the coding unit with a skip mode. However, these are for illustrative purposes only, and are not meant to be limitations of the present invention.

Regarding 3-mode activity indication, it will give three different instructions to the video encoder circuit 304. For example, a plurality of 3-mode activity indication maps are associated with the processed frames 103, respectively. That is, a 3-mode activity indication map associated with a current processed frame to be encoded by the video encoder 304 is referenced by the video encoder 304 to determine how to encode each coding unit (coding block) within the current processed frame. When a coding unit (coding block) in a current processed frame to be encoded is found being associated with the non-static pixel data indication 504 recorded in a 3-mode activity indication map, the video encoder circuit 304 may encode the coding unit (coding block) in a typical manner as specified by a coding standard. When a coding unit (coding block) in a current processed frame to be encoded is found being associated with the static pixel data indication 502 recorded in the 3-mode activity indication map, the video encoder circuit 304 may encode the coding unit with a skip mode. When a coding unit (coding block) in a current processed frame to be encoded is found being associated with the contour of motion (or static) pixel data indication 506, the video encoder circuit 304 may force a coded motion vector of the coding unit to zero, or may encode the coding unit without residual information, or may encode the coding unit with a skip mode. However, these are for illustrative purposes only, and are not meant to be limitations of the present invention.

Compared to the video encoder circuit 104 that encodes each coding unit (coding block) of a processed frame in a typical manner as specified by a coding standard, the video encoder circuit 304 that refers to the activity indication 301 to encode each coding unit (coding block) of a processed frame can make a reconstructed frame (decoded frame) at a decoder side have better image quality. It should be noted that the video encoder circuit 304 may be implemented by any suitable encoder architecture. That is, the present invention has no limitations on the encoder architecture employed by the video encoder circuit 304.

FIG. 6 is a diagram illustrating a third video encoding apparatus according to an embodiment of the present invention. The video encoding apparatus 600 includes a video encoder circuit (labeled by “video encoder”) 604 and the aforementioned content activity analyzer circuit (labeled by “content activity analyzer”) 302. The video encoder circuit 604 is arranged to perform a video encoding process to generate a bitstream output of the video encoding apparatus 600, wherein information derived from the content activity analysis results (e.g. activity indication 301) is referenced by the video encoding process. It should be noted that the processed frames 103 generated by the content activity analyzer circuit 302 are used for content activity analysis only, and are not encoded into the output bitstream by the video encoder circuit 604.

In this embodiment, the input frames 101 are encoded with the aid of the activity indication 301. For example, the activity indication 301 may include a plurality of activity indication maps associated with all input frames 101 except the first input frame F1, respectively. In a case where 2-mode activity indication shown in FIG. 4 is adopted, the 2-mode activity indication will give two different instructions to the video encoder circuit 604. In another case where 3-mode activity indication shown in FIG. 5 is adopted, the 3-mode activity indication will give three different instructions to the video encoder circuit 604. When a coding unit (coding block) in a current input frame to be encoded is found being associated with one activity indication recorded in the 2-mode activity indication map (or 3-mode activity indication map), the video encoder circuit 604 may encode the coding unit (coding block) in a manner as instructed by the activity indication. Hence, the video encoder circuit 604 encodes the input frame F1 to generate a first frame bitstream included in the bitstream output, encodes the input frame F2 according to the activity indication 301 (particularly, activity indication map derived from input frames F2 and F1), to generate a second frame bitstream included in the bitstream output, encodes the input frame F3 according to the activity indication 301 (particularly, activity indication map derived from input frame F3 and processed frame F2′), to generate a third frame bitstream included in the bitstream output, and so forth. It should be noted that the video encoder circuit 604 may be implemented by any suitable encoder architecture. That is, the present invention has no limitations on the encoder architecture employed by the video encoder circuit 604.

In above embodiments, each of the content activity analyzer circuits 102 and 302 performs the content activity analysis process under an image resolution of the input frames 101. For example, the image resolution of each input frame may be 3840×2160. To get better video quality and lower bit-rate, a pre-processing circuit may be introduced to the video encoding apparatus.

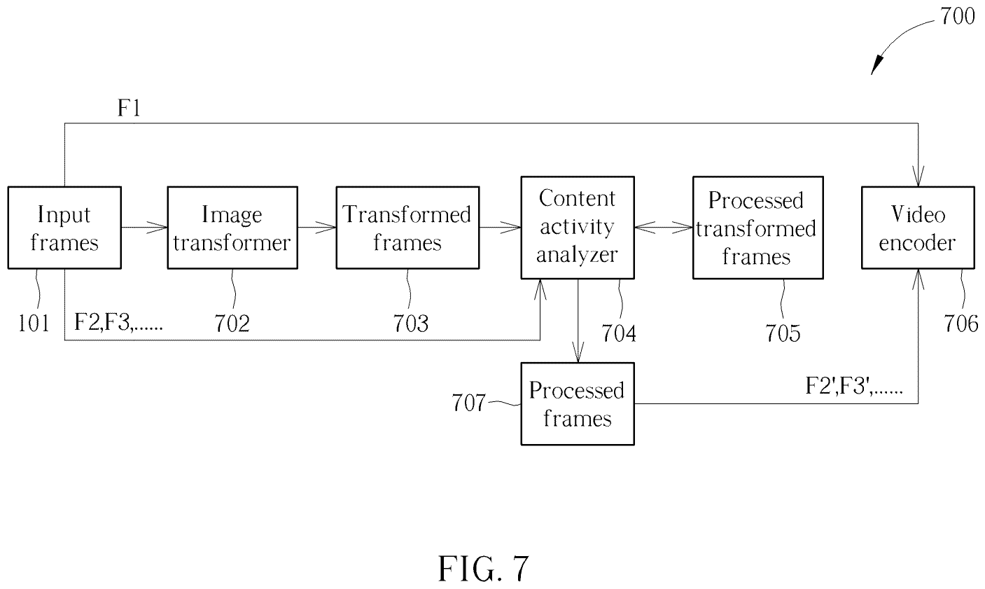

FIG. 7 is a diagram illustrating a fourth video encoding apparatus according to an embodiment of the present invention. The video encoding apparatus 700 includes an image transformer circuit (labeled by “image transformer”) 702, a content activity analyzer circuit (labeled by “content activity analyzer”) 704 and a video encoder circuit (labeled by “video encoder”) 706. The image transformer circuit 702 acts as a pre-processing circuit, and is arranged to apply an image transform process to the input frames 101 of the video encoding apparatus 700, to generate transformed frames 703 as consecutive frames to undergo a content activity analysis process at the content activity analyzer circuit 704. The image transform process may include a down-sampling operation, such that an image resolution (e.g. 960×540) of one transformed frame output from the image transformer circuit 702 is lower than an image resolution (e.g. 3840×2160) of one input frame received by the image transformer circuit 702. The down-sampling operation can reduce the complexity of the content activity analyzer circuit 704. In addition, the down-sampling operation can reduce the noise level, which makes the content activity analyzer circuit 704 more robust to noise.

The content activity analyzer circuit 704 is arranged to apply a content activity analysis process to consecutive frames, to generate content activity analysis results. In this embodiment, the consecutive frames received by the content activity analyzer circuit 704 are transformed frames 703, and the content activity analysis results generated by the content activity analyzer circuit 704 include processed transformed frames 705 and processed frames 707. The processed transformed frames 705 and the transformed frames 703 may have the same image resolution (e.g. 960×540). The processed frames 707 and the input frames 101 may have the same image resolution (e.g. 3840×2160).

It should be noted that, in accordance with the proposed content activity analysis process, a previous processed transformed frame 705 generated for a previous transformed frame 703 may be referenced by the content activity analyzer circuit 704 for content activity analysis of a current transformed frame, and a current processed frame may be derived from a current input frame and a previous input frame (or a previous processed frame) according to information given from content activity analysis of the current transformed frame and the previous transformed frame (or previous processed transformed frame).

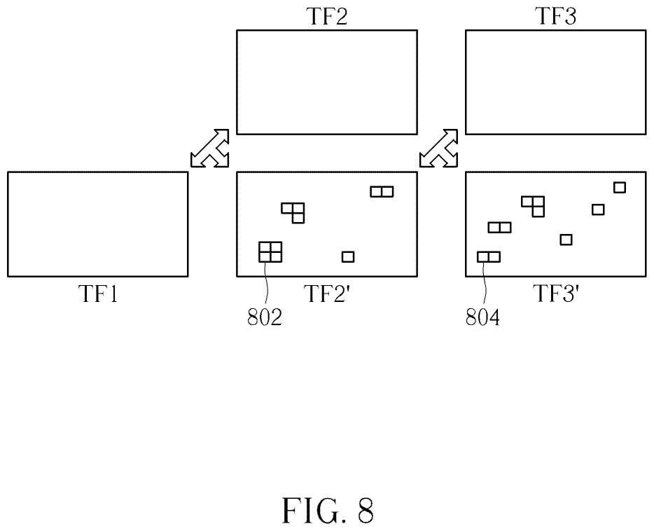

FIG. 8 is a diagram illustrating a post-transform content activity analysis process according to an embodiment of the present invention. The transformed frames 703 include consecutive frames, such as frames TF1, TF2, and TF3 that are derived from input frames F1, F2, and F3 through image transform, respectively. The content activity analyzer circuit 704 derives a processed transformed frame TF2′ according to the transformed frames TF1 and TF2. Specifically, the content activity analyzer circuit 704 performs content activity analysis of pixel data of transformed frames TF1 and TF2 to identify static pixel data in the transformed frame TF2, where the static pixel data means that there is no motion activity between a current frame (e.g. transformed frame TF2) and a previous frame (e.g. transformed frame TF1). In addition, the content activity analyzer circuit 704 derives processed pixel data 802, and generates the processed transformed frame TF2′ by replacing the static pixel data identified in the transformed frame TF2 with the processed pixel data 802. For example, the processed pixel data 802 is static pixel data in the transformed frame TF1. For another example, the processed static pixel data 802 is generated by applying an arithmetic operation to pixel data in the transformed frames TF1 and TF2.

The processed transformed frame TF2′ is distinct from the transformed frame TF2, and may be used as a substitute of the transformed frame TF2 for following content activity analysis. Compared to content activity analysis of pixel data of transformed frames TF3 and TF2, content activity analysis of pixel data of transformed frame TF3 and processed transformed frame TF2′ can produce a more accurate static pixel data detection result. As shown in FIG. 8, the content activity analyzer circuit 704 derives a processed transformed frame TF3′ according to the transformed frame TF3 and the processed transformed frame TF2′. Specifically, the content activity analyzer circuit 704 performs content activity analysis of pixel data of transformed frame TF3 and processed transformed frame TF2′ to identify static pixel data in the transformed frame TF3, where the static pixel data means that there is no motion activity between a current frame (e.g. transformed frame TF3) and a previous frame (e.g. processed transformed frame TF2′). In addition, the content activity analyzer circuit 704 derives processed pixel data 804, and generates the processed transformed frame TF3′ by replacing the static pixel data identified in the transformed frame TF3 with the processed pixel data 804. For example, the processed pixel data 804 is static pixel data in the processed transformed frame TF2′. For another example, the processed static pixel data 804 is generated by applying an arithmetic operation to pixel data in the transformed frame TF3 and processed transformed frame TF2′. Similarly, the processed transformed frame TF3′ is distinct from the transformed frame TF3, and may be used as a substitute of the transformed frame TF3 for following content activity analysis. Similar description is omitted here for brevity.

As mentioned above, the image resolution of processed frames 707 is higher than that of transformed frames 703 and processed transformed frames 705. With proper scaling and mapping, locations of static pixel data in the input frame F2 can be predicted on the basis of locations of static pixel data identified in the transformed frame TF2. Hence, the content activity analyzer circuit 704 derives processed pixel data, and generates the processed frame F2′ by replacing the static pixel data predicted in the input frame F2 with the processed pixel data. For example, the processed pixel data is static pixel data in the input frame F1. For another example, the processed static pixel data is generated by applying an arithmetic operation to pixel data in the input frames F1 and F2.

Similarly, with proper scaling and mapping, locations of static pixel data in the input frame F3 can be predicted on the basis of locations of static pixel data identified in the transformed frame TF3. Hence, the content activity analyzer circuit 704 derives processed pixel data, and generates the processed frame F3′ by replacing the static pixel data predicted in the input frame F3 with the processed pixel data. For example, the processed pixel data is static pixel data in the processed frame F2′. For another example, the processed static pixel data is generated by applying an arithmetic operation to pixel data in the input frame F3 and processed frame F2′.

The video encoder circuit 706 is arranged to perform a video encoding process to generate a bitstream output of the video encoding apparatus 700, wherein information derived from the content activity analysis results (e.g. processed frames 707) is referenced by the video encoding process. In this embodiment, the video encoder circuit 706 encodes the input frame F1 to generate a first frame bitstream included in the bitstream output, encodes the processed frame F2′ to generate a second frame bitstream included in the bitstream output, encodes the processed frame F3′ to generate a third frame bitstream included in the bitstream output, and so forth. It should be noted that the video encoder circuit 706 may be implemented by any suitable encoder architecture. That is, the present invention has no limitations on the encoder architecture employed by the video encoder circuit 706.

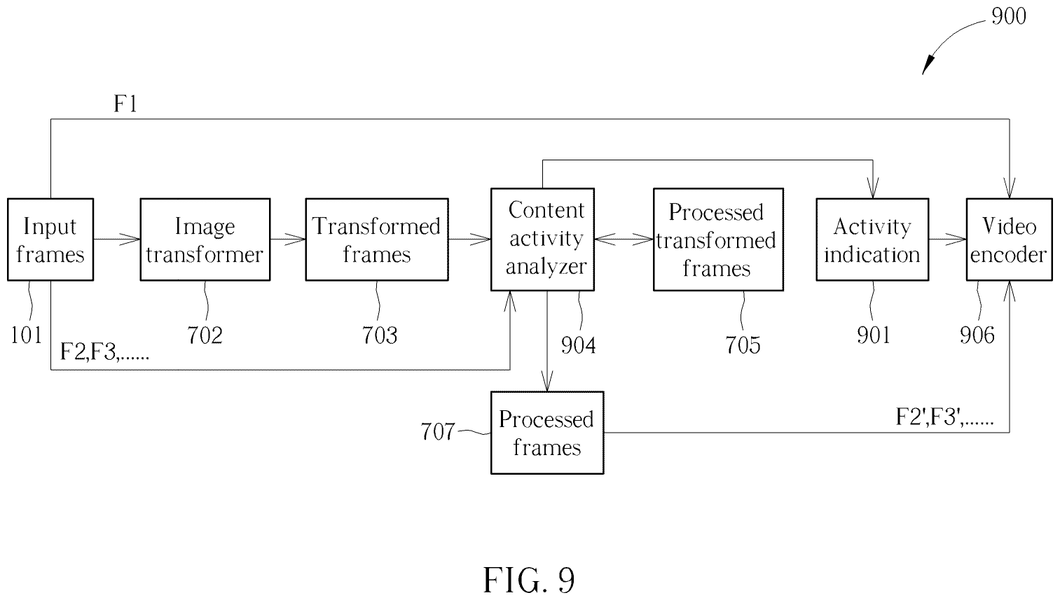

FIG. 9 is a diagram illustrating a fifth video encoding apparatus according to an embodiment of the present invention. The video encoding apparatus 900 includes a content activity analyzer circuit (labeled by “content activity analyzer”) 904, a video encoder circuit (labeled by “video encoder”) 906, and the aforementioned image transformer circuit (labeled by “image transformer”) 702. Like the content activity analyzer circuit 704, the content activity analyzer circuit 904 is arranged to apply a content activity analysis process to consecutive frames, to generate content activity analysis results. In this embodiment, the consecutive frames received by the content activity analyzer circuit 904 are transformed frames 703. The difference between the content activity analyzer circuits 904 and 704 is that the content activity analysis results generated by the content activity analyzer circuit 904 include processed frames 707, processed transformed frames 705, and activity indication 901. Since the principles of generating the processed transformed frames 705 and the processed frames 707 are described in above paragraphs, further description is omitted here for brevity. In some embodiments of the present invention, the activity indication 901 may be generated after the processed transformed frames 705 are derived from content activity analysis of the transformed frames 703. The generation of the activity indication 901 depends on the content activity analysis applied to the transformed frames 703. In other words, the activity indication 901 may be a byproduct of the content activity analysis process performed by the content activity analyzer circuit 904. For example, the activity indication 901 may include a plurality of activity indication maps, each recording one activity indication for each of a plurality of blocks of pixels.

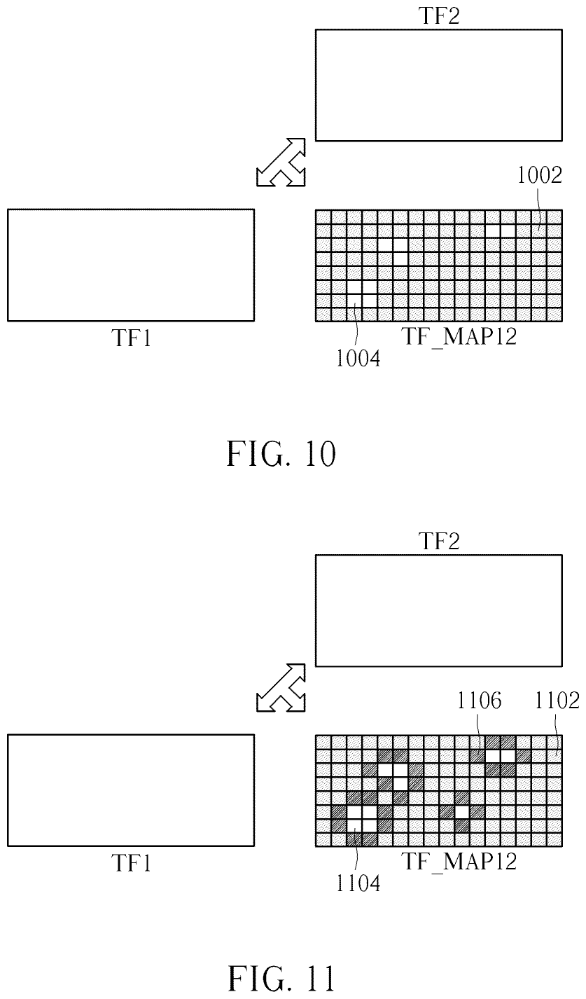

FIG. 10 is a diagram illustrating 2-mode activity indication derived from consecutive frames (e.g. two transformed frames, or one transformed frame and one processed transformed frame) according to an embodiment of the present invention. The difference between 2-mode activity indication computation shown in FIGS. 4 and 2-mode activity indication computation shown in FIG. 10 is the frames involved in content activity analysis. As shown in FIG. 10, the content activity analyzer circuit 904 may perform content activity analysis of pixel data in the transformed frames TF1 and TF2 to generate an activity indication map TF_MAP12 that is a 2-mode activity indication map including static pixel data indication 1002 and non-static pixel data indication 1004, where the static pixel data indication 1002 means no motion activity between co-located blocks in transformed frames TF1 and TF2, and the non-static pixel data indication 1004 means motion activity between co-located blocks in transformed frames TF1 and TF2. Alternatively, the transformed frames TF1 and TF2 shown in FIG. 10 may be replaced with a transformed frame (e.g. TF3) and a processed transformed frame (e.g. TF2′), such that a 2-mode activity indication map is derived from content activity analysis of pixel data in the transformed frame and the processed transformed frame.

FIG. 11 is a diagram illustrating 3-mode activity indication derived from consecutive frames (e.g. transformed frames, or one transformed frame and one processed transformed frame) according to an embodiment of the present invention. The difference between 3-mode activity indication computation shown in FIGS. 5 and 3-mode activity indication computation shown in FIG. 11 is the frames involved in content activity analysis. As shown in FIG. 11, the content activity analyzer circuit 904 may perform content activity analysis of pixel data in the transformed frames TF1 and TF2 to generate an activity indication map TF_MAP12 that is a 3-mode activity indication map including static pixel data indication 1102, non-static pixel data indication 1104, and contour of motion (or static) pixel data indication 1106, where the static pixel data indication 1102 means no motion activity between co-located blocks in transformed frames TF1 and TF2, the non-static pixel data indication 1104 means motion activity between co-located blocks in transformed frames TF1 and TF2, and the contour of motion (or static) pixel data indication 1106 means the contour of motion activity between transformed frames TF1 and TF2. Alternatively, the transformed frames TF1 and TF2 shown in FIG. 11 may be replaced with a transformed frame (e.g. TF3) and a processed transformed frame (e.g. TF2′), such that a 3-mode activity indication map is derived from content activity analysis of pixel data in the transformed frame and the processed transformed frame.

The video encoder circuit 906 is arranged to perform a video encoding process to generate a bitstream output of the video encoding apparatus 900, wherein information derived from the content activity analysis results (e.g. processed frames 707 and activity indication 901) is referenced by the video encoding process. In this embodiment, the video encoder circuit 906 encodes the input frame F1 to generate a first frame bitstream included in the bitstream output. Furthermore, with proper scaling and mapping of the activity indication 901, the video encoder circuit 906 encodes the processed frame F2′ according to the activity indication 901 (particularly, activity indication map derived from transformed frames TF2 and TF1), to generate a second frame bitstream included in the bitstream output, encodes the processed frame F3′ according to the activity indication 901 (particularly, activity indication map derived from transformed frame TF3 and processed transformed frame TF2′), to generate a third frame bitstream included in the bitstream output, and so forth.

Regarding 2-mode activity indication, it will give two different instructions to the video encoder circuit 906. For example, a plurality of 2-mode activity indication maps are associated with the processed frames 707, respectively. That is, a 2-mode activity indication map associated with a current processed frame to be encoded by the video encoder 906 is referenced by the video encoder 906 to determine how to encode each coding unit (coding block) within the current processed frame. When a coding unit (coding block) in a current processed frame to be encoded is found being associated with the non-static pixel data indication 1004 through proper scaling and mapping, the video encoder circuit 906 may encode the coding unit (coding block) in a typical manner as specified by a coding standard. When a coding unit (coding block) in a current processed frame to be encoded is found being associated with the static pixel data indication 1002 through proper scaling and mapping, the video encoder circuit 906 may force a coded motion vector of the coding unit to zero, or may encode the coding unit with a skip mode. However, these are for illustrative purposes only, and are not meant to be limitations of the present invention.

Regarding 3-mode activity indication, it will give three different instructions to the video encoder circuit 906. For example, a plurality of 3-mode activity indication maps are associated with the processed frames 707, respectively. That is, a 3-mode activity indication map associated with a current processed frame to be encoded by the video encoder 906 is referenced by the video encoder 906 to determine how to encode each coding unit (coding block) within the current processed frame. When a coding unit (coding block) in a current processed frame to be encoded is found being associated with the non-static pixel data indication 1104 through proper scaling and mapping, the video encoder circuit 906 may encode the coding unit (coding block) in a typical manner as specified by a coding standard. When a coding unit (coding block) in a current processed frame to be encoded is found being associated with the static pixel data indication 1102 through proper scaling and mapping, the video encoder circuit 906 may encode the coding unit with a skip mode. When a coding unit (coding block) in a current processed frame to be encoded is found being associated with the contour of motion (or static) pixel data indication 1106 through proper scaling and mapping, the video encoder circuit 906 may force a coded motion vector of the coding unit to zero, or may encode the coding unit without residual information, or may encode the coding unit with a skip mode. However, these are for illustrative purposes only, and are not meant to be limitations of the present invention.

Compared to the video encoder circuit 706 that encodes each coding unit (coding block) of a processed frame in a typical manner as specified by a coding standard, the video encoder circuit 906 that refers to the activity indication 901 to encode each coding unit (coding block) of a processed frame can make a reconstructed frame (decoded frame) at a decoder side have better image quality. It should be noted that the video encoder circuit 906 may be implemented by any suitable encoder architecture. That is, the present invention has no limitations on the encoder architecture employed by the video encoder circuit 906.

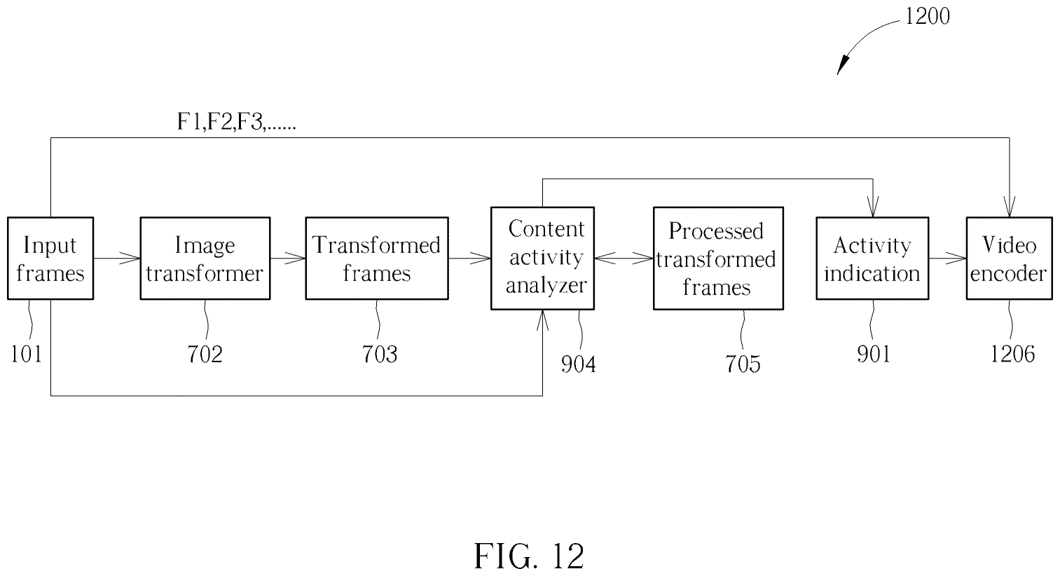

FIG. 12 is a diagram illustrating a sixth video encoding apparatus according to an embodiment of the present invention. The video encoding apparatus 1200 includes a video encoder circuit (labeled by “video encoder”) 1206 and the aforementioned image transformer circuit (labeled by “image transformer”) 702 and content activity analyzer circuit (labeled by “content activity analyzer”) 904. The video encoder circuit 1206 is arranged to perform a video encoding process to generate a bitstream output of the video encoding apparatus 1200, wherein information derived from the content activity analysis results (e.g. activity indication 901) is referenced by the video encoding process. The activity indication 901 may include a plurality of activity indication maps associated with the input frames 101, respectively. In this embodiment, the video encoder circuit 1206 encodes the input frame F1 to generate a first frame bitstream included in the bitstream output. Furthermore, with proper scaling and mapping of the activity indication 901, the video encoder circuit 1206 can encode the rest of the input frames 101 with the aid of the activity indication 901. The video encoder circuit 1206 encodes the input frame F2 according to the activity indication 901 (particularly, activity indication map derived from transformed frames TF2 and TF1), to generate a second frame bitstream included in the bitstream output, encodes the input frame F3 according to the activity indication 901 (particularly, activity indication map derived from transformed frame TF3 and processed transformed frame TF2′), to generate a third frame bitstream included in the bitstream output, and so forth. It should be noted that the video encoder circuit 1206 may be implemented by any suitable encoder architecture. That is, the present invention has no limitations on the encoder architecture employed by the video encoder circuit 1206.

In above embodiments, the activity indication 301 is generated by the content activity analyzer circuit 302 that uses the proposed content activity analysis process, where a current frame may be an input frame (e.g., F3), and a previous frame may be a processed frame (e.g., F2′) that acts as a substitute of an input frame (e.g., F2). In an alternative design, a content activity analysis process without using processed frames as substitutes of input frames may be employed to generate the activity indication 301 referenced by the video encoder circuit.

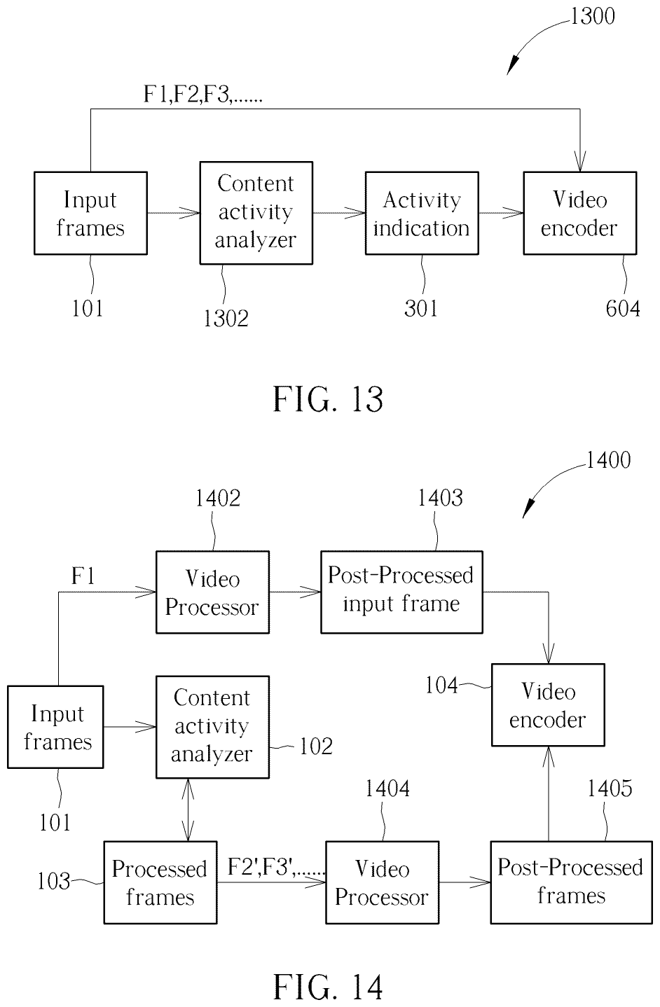

FIG. 13 is a diagram illustrating a seventh video encoding apparatus according to an embodiment of the present invention. The video encoding apparatus 1300 includes a content activity analyzer circuit (labeled by “content activity analyzer”) 1302 and the aforementioned video encoder circuit (labeled by “video encoder”) 604. The video encoder circuit 604 is arranged to perform a video encoding process to generate a bitstream output of the video encoding apparatus 1300, wherein information derived from the content activity analysis results (e.g. activity indication 301) is referenced by the video encoding process. In this embodiment, the content activity analyzer circuit 1302 is arranged to apply a content activity analysis process to consecutive frames, to generate content activity analysis results (e.g. activity indication 301), where the consecutive frames received by the content activity analyzer circuit 1302 are input frames 101 of the video encoding apparatus 1300. Hence, the content activity analyzer circuit 1302 generates activity indication 301 of a current frame (which is an input frame) according to the current frame (which is an input frame) and a previous frame (which is another input frame). For example, a content activity analysis result of an input frame F2 is generated based on input frames F2 and F1, a content activity analysis result of an input frame F3 is generated based on input frames F3 and F2, and so forth.

The input frames 101 are encoded with the aid of the activity indication 301. For example, the activity indication 301 may include a plurality of activity indication maps associated with all input frames 101 except the first input frame F1, respectively. In a case where 2-mode activity indication shown in FIG. 4 is adopted, the 2-mode activity indication will give two different instructions to the video encoder circuit 604. In another case where 3-mode activity indication shown in FIG. 5 is adopted, the 3-mode activity indication will give three different instructions to the video encoder circuit 604. When a coding unit (coding block) in a current input frame to be encoded is found being associated with one activity indication recorded in the 2-mode activity indication map (or 3-mode activity indication map), the video encoder circuit 604 may encode the coding unit (coding block) in a manner as instructed by the activity indication. Hence, the video encoder circuit 604 encodes the input frame F1 to generate a first frame bitstream included in the bitstream output, encodes the input frame F2 according to the activity indication 301 (particularly, activity indication map derived from input frames F2 and F1), to generate a second frame bitstream included in the bitstream output, encodes the input frame F3 according to the activity indication 301 (particularly, activity indication map derived from input frame F3 and F2), to generate a third frame bitstream included in the bitstream output, and so forth. It should be noted that the video encoder circuit 604 may be implemented by any suitable encoder architecture. That is, the present invention has no limitations on the encoder architecture employed by the video encoder circuit 604.

In above embodiments, the video encoder circuit 104/304/604/706/906/1206 is arranged to receive input frames, processed frames, and/or activity indication. In some embodiments of the present invention, input frames, processed frames, and/or activity indication may undergo certain post-processing before being sent to a video encoder circuit.

FIG. 14 is a diagram illustrating an eighth video encoding apparatus according to an embodiment of the present invention. The difference between the video encoding apparatus 100 shown in FIG. 1 and the video encoding apparatus 1400 shown in FIG. 14 is that the video encoding apparatus 1400 further includes one video processor circuit (labeled by “video processor”) 1402 for applying post-processing to the input frame F1 to generate a post-processed input frame 1403, and another video processor circuit (labeled by “video processor”) 1404 for applying post-processing to the processed frames 103 to generate post-processed frames 1405. For example, the post-processing performed at the video processor circuit 1402/1404 may include cropping, rotating, resizing, etc. However, these are for illustrative purposes only, and are not meant to be limitations of the present invention. In practice, the post-processing operations may be adjusted, depending upon actual design considerations.

The video encoder circuit 104 is arranged to perform a video encoding process to generate a bitstream output of the video encoding apparatus 1400, wherein information derived from the content activity analysis results (e.g. post-processed frames 1405 obtained from passing the processed frames 103 through the video processor circuit 1404) is referenced by the video encoding process. In this embodiment, the video encoder circuit 104 encodes a post-processed input frame (which is derived from passing the input frame F1 through the video processor circuit 1402) to generate a first frame bitstream included in the bitstream output, encodes a post-processed frame (which is obtained from passing the processed frame F2′ through the video processor circuit 1404) to generate a second frame bitstream included in the bitstream output, encodes a post-processed frame (which is obtained from passing the processed frame F3′ through the video processor circuit 1404) to generate a third frame bitstream included in the bitstream output, and so forth. It should be noted that the video encoder circuit 104 may be implemented by any suitable encoder architecture. That is, the present invention has no limitations on the encoder architecture employed by the video encoder circuit 104.

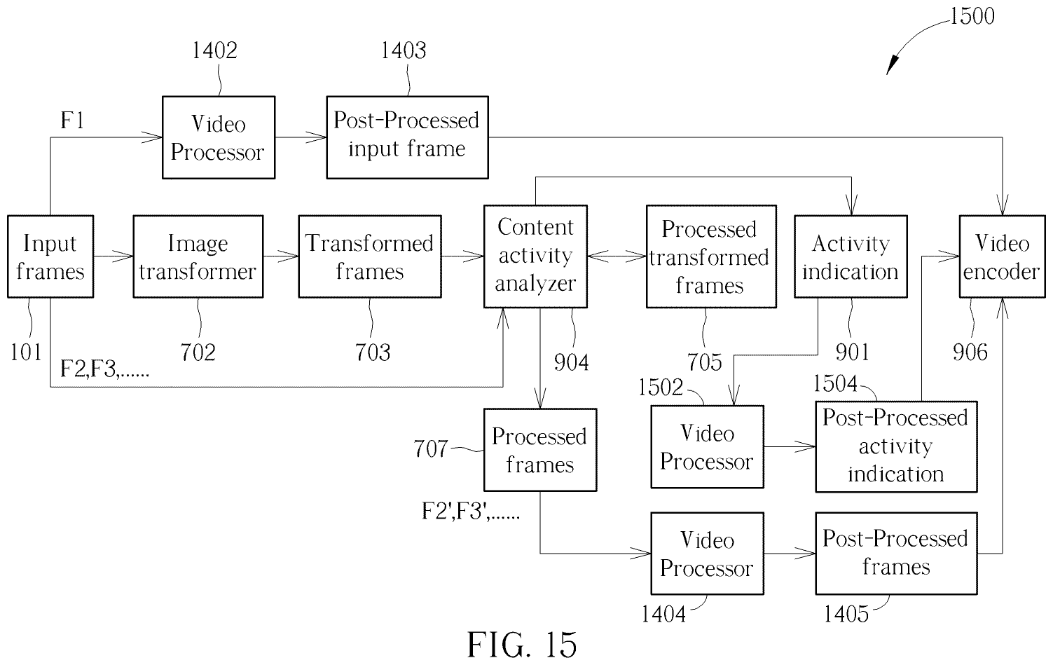

FIG. 15 is a diagram illustrating a ninth video encoding apparatus according to an embodiment of the present invention. The difference between the video encoding apparatus 900 shown in FIG. 9 and the video encoding apparatus 1500 shown in FIG. 15 is that the video encoding apparatus 1500 further includes one video processor circuit (labeled by “video processor”) 1402 for applying post-processing to the input frame F1 to generate a post-processed input frame 1403, another video processor circuit (labeled by “video processor”) 1404 for applying post-processing to the processed frames 707 to generate post-processed frames 1405, and yet another video processor circuit (labeled by “video processor”) 1502 for applying post-processing to the activity indication 901 to generate post-processed activity indication 1504. For example, the post-processing performed at the video processor circuit 1402/1404/1502 may include cropping, rotating, resizing, etc. However, these are for illustrative purposes only, and are not meant to be limitations of the present invention. In practice, the post-processing operations may be adjusted, depending upon actual design considerations.

The video encoder circuit 906 is arranged to perform a video encoding process to generate a bitstream output of the video encoding apparatus 1500, wherein information derived from the content activity analysis results (e.g. post-processed frames 1405 and post-processed activity indication 1504) is referenced by the video encoding process. In this embodiment, the video encoder circuit 906 encodes a post-processed input frame (which is obtained from passing the input frame F1 through the video processor circuit 1402) to generate a first frame bitstream included in the bitstream output. Furthermore, with proper scaling and mapping of the post-processed activity indication 1504 (which is obtained from passing the activity indication 901 through the video processor circuit 1502), the video encoder circuit 906 encodes a post-processing frame (which is obtained from passing the processed frame F2′ through the video processor circuit 1404) according to the post-processed activity indication 1504 (particularly, 2-mode activity indication map shown in FIG. 10 or 3-mode activity indication map shown in FIG. 11), to generate a second frame bitstream included in the bitstream output, encodes a post-processed frame (which is obtained from passing the processed frame F3′ through the video processor circuit 1404) according to the post-processed activity indication 1504 (particularly, 2-mode activity indication map shown in FIG. 10 or 3-mode activity indication map shown in FIG. 11), to generate a third frame bitstream included in the bitstream output, and so forth.

It should be noted that the image transform feature may be optional. That is, the image transformer circuit 702, transformed frames 703, and processed transformed frames 705 shown in FIG. 15 may be omitted, depending upon actual design considerations.

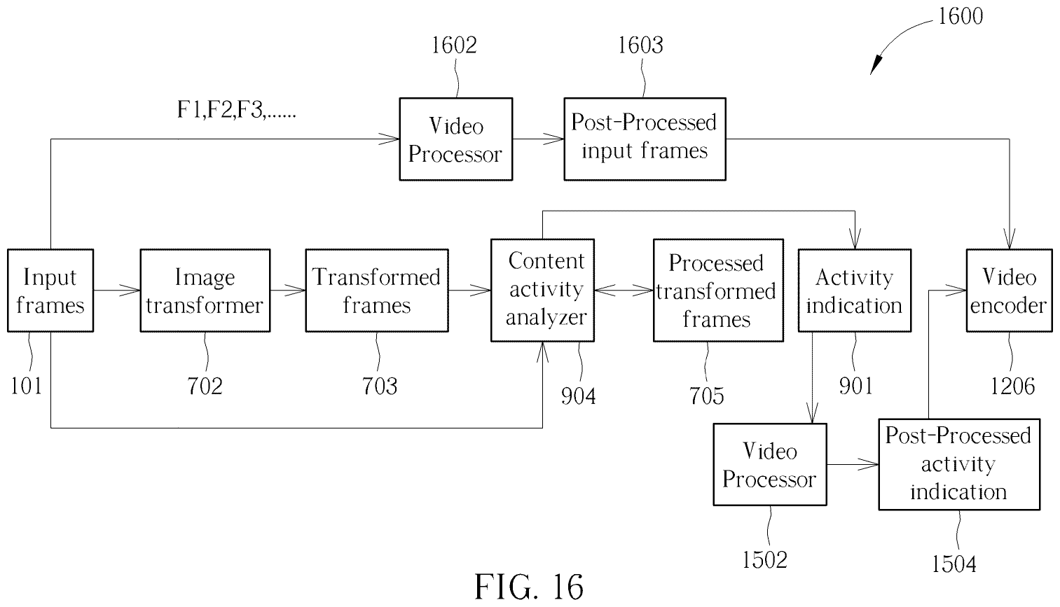

FIG. 16 is a diagram illustrating a tenth video encoding apparatus according to an embodiment of the present invention. The difference between the video encoding apparatus 1200 shown in FIG. 12 and the video encoding apparatus 1600 shown in FIG. 16 is that the video encoding apparatus 1600 further includes one video processor circuit (labeled by “video processor”) 1602 for applying post-processing to all of the input frames 101 (which include F1, F2, F3, . . . ) to generate post-processed input frames 1603, and another video processor circuit (labeled by “video processor”) 1502 for applying post-processing to the activity indication 901 to generate post-processed activity indication 1504. For example, the post-processing performed at the video processor circuit 1602/1502 may include cropping, rotating, resizing, etc. However, these are for illustrative purposes only, and are not meant to be limitations of the present invention. In practice, the post-processing operations may be adjusted, depending upon actual design considerations.

The video encoder circuit 1206 is arranged to perform a video encoding process to generate a bitstream output of the video encoding apparatus 1600, wherein information derived from the content activity analysis results (e.g. post-processed activity indication 1504 obtained from passing the activity indication 901 through the video processor circuit 1502) is referenced by the video encoding process. The post-processed activity indication 1504 may include a plurality of activity indication maps (e.g., 2-mode activity indication maps shown in FIG. 10 or 3-mode activity indication maps shown in FIG. 11) associated with the post-processed input frames 1603, respectively. In this embodiment, the video encoder circuit 1206 encodes a post-processed input frame (which is obtained from passing the input frame F1 through the video processor circuit 1602) to generate a first frame bitstream included in the bitstream output. Furthermore, with proper scaling and mapping of the post-processed activity indication 1504 (which is obtained from passing the activity indication 901 through the video processor circuit 1502), the video encoder circuit 1206 can encode the rest of the post-processed input frames with the aid of the post-processed activity indication 1504. The video encoder circuit 1206 encodes a post-processed input frame (which is obtained from passing the input frame F2 through the video processor circuit 1602) according to the post-processed activity indication 1504 (particularly, 2-mode activity indication map shown in FIG. 10 or 3-mode activity indication map shown in FIG. 11), to generate a second frame bitstream included in the bitstream output, encodes a post-processed input frame (which is obtained from passing the input frame F3 through the video processor circuit 1602) according to the post-processed activity indication 1504 (particularly, 2-mode activity indication map shown in FIG. 10 or 3-mode activity indication map shown in FIG. 11), to generate a third frame bitstream included in the bitstream output, and so forth. It should be noted that the video encoder circuit 1206 may be implemented by any suitable encoder architecture. That is, the present invention has no limitations on the encoder architecture employed by the video encoder circuit 1206.

It should be noted that the image transform feature may be optional. That is, the image transformer circuit 702, transformed frames 703, and processed transformed frames 705 shown in FIG. 16 may be omitted, depending upon actual design considerations.

As mentioned above, the content activity analyzer circuit is used to generate a content activity analysis result (which may include a processed frame and/or a 2-mode/3-mode activity indication map) of a current frame (which may be an input frame or a transformed frame) according to the current frame (which may be an input frame or a transformed frame) and a previous frame (which may be an input frame, a transformed frame, a processed frame, or a processed transformed frame). It is possible that the current frame is almost the same as the previous frame. For example, there is no motion or less motion between the current frame and the previous frame. Regarding low bit-rate video compression, encoding of the current frame at an encoder side may be skipped due to no motion or less motion, and decoding of the previous frame at a decoder side may be used to recover the current frame that is not encoded in the bitstream sent from the encoder side to the decoder side. For example, a content activity analyzer circuit of a video encoding apparatus is arranged to apply a content activity analysis process to a plurality of frames, and generate a plurality of content activity analysis results, wherein the frames are derived from a plurality of input frames of the video encoding apparatus; and a video encoder circuit of the video encoding apparatus is arranged to perform a video encoding process to generate a bitstream output of the video encoding apparatus. In accordance with the proposed skip-frame scheme, at least one frame is not encoded into the bitstream output of the video encoding apparatus according to the content activity analysis results. Further details of the proposed skip-frame scheme are provided as below with reference to the accompanying drawings.

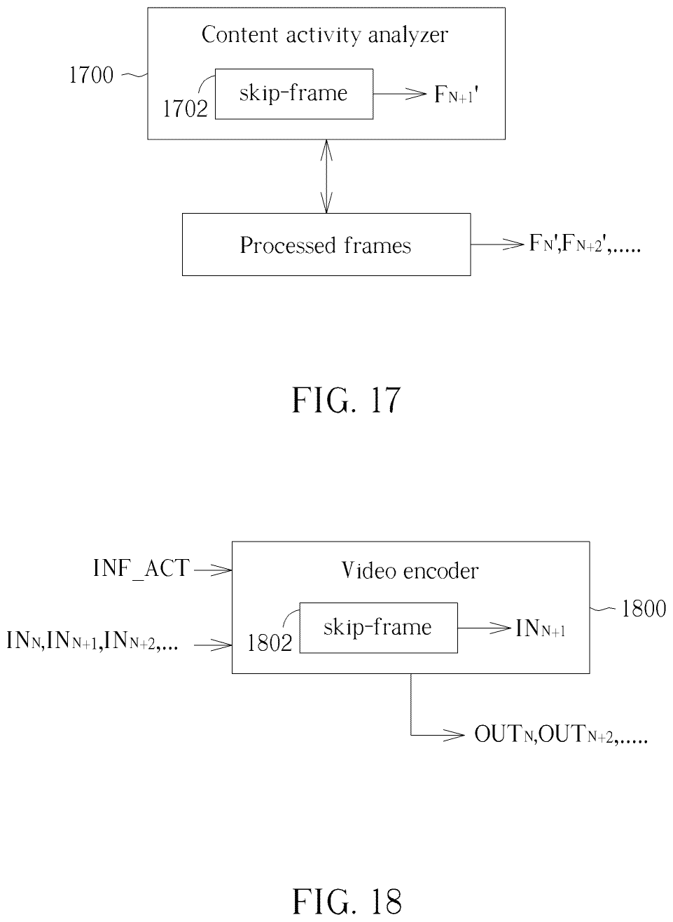

FIG. 17 is a diagram illustrating a content activity analyzer circuit with a skip-frame function according to an embodiment of the present invention. By way of example, but not limitation, any of the content activity analyzer circuit 102 shown in FIG. 1, the content activity analyzer circuit 704 shown in FIG. 7, and the content activity analyzer circuit 102 shown in FIG. 14 may be replaced by the content activity analyzer circuit 1700 with the skip-frame function 1702. The content activity analyzer circuit 1700 is arranged to apply a content activity analysis process to a current frame according to the current frame and a previous frame, and skip generation of a processed frame (e.g., F_{N+1}′) in a content activity analysis result of the current frame according to similarity between the current frame and the previous frame, where the at least one frame not encoded into the bitstream output corresponds to the processed frame (e.g., F_{N+1}′) intentionally skipped by the skip-frame function 1702 of the content activity analyzer circuit 1700 for low bit-rate video compression. Specifically, in response to the similarity between the current frame and the previous frame that indicates motion between the current frame and the previous frame is smaller than a threshold (e.g., no motion or less motion), the content activity analyzer circuit 1700 skips generation of the processed frame (e.g., F_{N+1}′). As shown in FIG. 17, a processed frame F_{N}′ corresponding to the previous frame and a processed frame F_{N+2}′ corresponding to a next frame are not skipped by the content activity analyzer circuit 1700, and are provided to the following processing stage (e.g., video encoder or video processor).

Suppose that the content activity analyzer circuit 102 shown in FIG. 1 or FIG. 14 is replaced by the content activity analyzer circuit 1700. The frames received by the content activity analyzer circuit 1700 are input frames 101 of the video encoding apparatus 100/1400, respectively. In a case where the processed fame F2′ is skipped by the content activity analyzer circuit 1700, the current frame checked by the content activity analyzer circuit 1700 may be the input frame F2, and the previous frame checked by the content activity analyzer circuit 1700 may be the input frame F1. Since the processed fame F2′ is not generated, the content activity analysis process applied to the next frame F3 may rely on the next frame F3 and the previous frame F1. In another case where the processed fame F3′ is skipped by the content activity analyzer circuit 1700, the current frame checked by the content activity analyzer circuit 1700 may be the input frame F3, and the previous frame checked by the content activity analyzer circuit 1700 may be the processed frame F2′. Since the processed fame F3′ is not generated, the content activity analysis process applied to the next frame F4 may rely on the next frame F4 and the previous frame F2 or F2′.

Suppose that the content activity analyzer circuit 704 shown in FIG. 7 is replaced by the content activity analyzer circuit 1700. The frames received by the content activity analyzer circuit 1700 are transformed frames 703 output by the image transformer circuit 702, respectively. In a case where a processed transformed frame TF2′ is skipped by the content activity analyzer circuit 1700, the current frame checked by the content activity analyzer circuit 1700 is the transformed frame TF2, and the previous frame checked by the content activity analyzer circuit 1700 is the transformed frame TF1. Since the processed transformed fame TF2′ is not generated, the content activity analysis process applied to the next frame TF3 may rely on the next frame TF3 and the previous frame TF1. In another case where a processed transformed frame TF3′ is skipped by the content activity analyzer circuit 1700, the current frame checked by the content activity analyzer circuit 1700 is the transformed frame TF3, and the previous frame checked by the content activity analyzer circuit 1700 is the processed transformed frame TF2′. Since the processed transformed fame TF3′ is not generated, the content activity analysis process applied to the next frame TF4 may rely on the next frame TF4 and the previous frame TF2 or TF2′.

FIG. 18 is a diagram illustrating a video encoder circuit with a skip-frame function according to an embodiment of the present invention. By way of example, but not limitation, any of the video encoder circuit 304 shown in FIG. 3, the video encoder circuit 604 shown in FIG. 6, the video encoder circuit 906 shown in FIG. 9, the video encoder circuit 1206 shown in FIG. 12, the video encoder circuit 604 shown in FIG. 13, the video encoder circuit 906 shown in FIG. 15, and the video encoder circuit 1206 shown in FIG. 16 may be replaced by the video encoder circuit 1800 with the skip-frame function 1802. The content activity analyzer circuit 302/704/904/1302 applies a content activity analysis process to a current frame according to the current frame and a previous frame, and generates a content activity analysis result of the current frame, where the content activity analysis result includes activity indication 301/901 indicative of similarity between the current frame and the previous frame. In accordance with the proposed skip-frame scheme, at least one frame (e.g., IN_{N+1}) received by the video encoder circuit 1800 and not encoded into the bitstream output corresponds to the current frame. Specifically, in response to the similarity between the current frame and the previous frame that indicates motion between the current frame and the previous frame is smaller than a threshold (e.g., no motion or less motion), the at least one frame (e.g., IN_{N+1}) is not encoded into the bitstream output. In this embodiment, the video encoder circuit 1800 (particularly, skip-frame function 1802 of video encoder circuit 1800) refers to the activity indication INF_ACT to skip encoding of the at least one frame (e.g., IN_{N+1}) received by the video encoder circuit 1800. As shown in FIG. 18, a frame IN_{N} received by the video encoder circuit 1800 corresponds to the previous frame, and is encoded as a frame bitstream OUT_{N} included in the bitstream output; and a frame IN_{N+2} received by the video encoder circuit 1800 corresponds to the next frame, and is encoded as a frame bitstream OUT_{N+2} included in the bitstream output.

In a case where the video encoder circuit 604 shown in FIG. 6, the video encoder circuit 1206 shown in FIG. 12, or the video encoder circuit 604 shown in FIG. 13 is replaced by the video encoder circuit 1800 with the skip-frame function 1802, the activity indication INF_ACT received by the video encoder circuit 1800 may be activity indication 301/901, and the at least one frame (e.g., IN_{N+1}) skipped by the video encoder circuit 1800 may be at least one of the input frames 101.

In a case where the video encoder circuit 304 shown in FIG. 3 or the video encoder circuit 906 shown in FIG. 9 is replaced by the video encoder circuit 1800 with the skip-frame function 1802, the activity indication INF_ACT received by the video encoder circuit 1800 may be activity indication 301/901, and the at least one frame (e.g., IN_{N+1}) skipped by the video encoder circuit 1800 may be at least one of the processed frames 103/707.

In a case where the video encoder circuit 1206 shown in FIG. 16 is replaced by the video encoder circuit 1800 with the skip-frame function 1802, the activity indication INF_ACT received by the video encoder circuit 1800 may be post-processed activity indication 1504, and the at least one frame (e.g., IN_{N+1}) skipped by the video encoder circuit 1800 may be at least one of the post-processed input frames 1603.

In a case where the video encoder circuit 906 shown in FIG. 15 is replaced by the video encoder circuit 1800 with the skip-frame function 1802, the activity indication INF_ACT received by the video encoder circuit 1800 may be post-processed activity indication 1504, and the at least one frame (e.g., IN_{N+1}) skipped by the video encoder circuit 1800 may be at least one of the post-processed frames 1405.

Furthermore, regarding the embodiments shown in FIGS. 9, 12, 15, and 16 that are modified to employ the video encoder circuit 1800 with the skip-frame function 1802, the content activity analyzer circuit 904 may or may not generate a new processed transformed frame when activity indication indicates that a frame that is received by the video encoder circuit 1800 and corresponds to the current frame should be skipped by the video encoder circuit 1800.

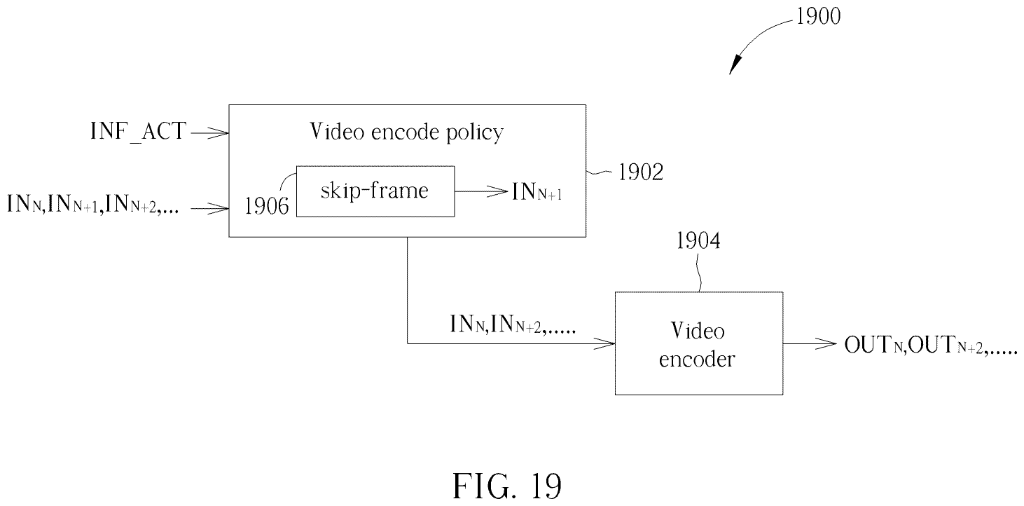

FIG. 19 is a diagram illustrating an encode-policy-aided video encoder circuit according to an embodiment of the present invention. By way of example, but not limitation, any of the video encoder circuit 304 shown in FIG. 3, the video encoder circuit 604 shown in FIG. 6, the video encoder circuit 906 shown in FIG. 9, the video encoder circuit 1206 shown in FIG. 12, the video encoder circuit 604 shown in FIG. 13, the video encoder circuit 906 shown in FIG. 15, and the video encoder circuit 1206 shown in FIG. 16 may be replaced by the encode-policy-aided video encoder circuit 1900. The encode-policy-aided video encoder circuit 1900 includes a video encode policy circuit (labeled by “video encode policy”) 1902 and a video encoder circuit (labeled by “video encoder”) 1904, where the video encoder circuit 1904 may be a typical video encoder that does not support the proposed skip-frame scheme. In this embodiment, the video encode policy circuit 1902 with a skip-frame function 1906 is employed to achieve the objective of skipping encoding of no-motion/less-motion frames for low bit-rate video compression.

The content activity analyzer circuit 302/704/904/1302 applies a content activity analysis process to a current frame according to the current frame and a previous frame, and generates a content activity analysis result of the current frame, where the content activity analysis result includes activity indication 301/901 indicative of similarity between the current frame and the previous frame. The video encode policy circuit 1902 determines whether a frame received by the video encode policy circuit 1902 should be fed into the following video encoder circuit 1904 for encoding. In accordance with the proposed skip-frame scheme, at least one frame (e.g., IN_{N+1}) received by the video encode policy circuit 1902 is not fed into the video encoder circuit 1904, where the at least one frame (e.g., IN_{N+1}) not encoded into the bitstream output corresponds to the current frame. Specifically, in response to the similarity between the current frame and the previous frame that indicates motion between the current frame and the previous frame is smaller than a threshold (e.g., no motion or less motion), the at least one frame (e.g., IN_{N+1}) is not fed into the video encoder circuit 1904 by the video encode policy circuit 1902, such that the at least one frame (e.g., IN_{N+1}) is not encoded into the bitstream output. In this embodiment, the video encode policy circuit 1902 (particularly, skip-frame function 1906 of video encode policy circuit 1902) refers to the activity indication INF_ACT to skip the at least one frame (e.g., IN_{N+1}) received by the video encode policy circuit 1902. As shown in FIG. 18, a frame IN_{N} received by the video encode policy circuit 1902 corresponds to the previous frame, and is fed into the video encoder circuit 1904 and then encoded as a frame bitstream OUT_{N} included in the bitstream output; and a frame IN_{N+2} received by the video encode policy circuit 1902 corresponds to the next frame, and is fed into the video encoder circuit 1904 and then encoded as a frame bitstream OUT_{N+2} included in the bitstream output.

In a case where the video encoder circuit 604 shown in FIG. 6, the video encoder circuit 1206 shown in FIG. 12, or the video encoder circuit 604 shown in FIG. 13 is replaced by the encode-policy-aided video encoder circuit 1900, the activity indication INF_ACT received by the video encode policy circuit 1902 may be activity indication 301/901, and the at least one frame (e.g., IN_{N+1}) skipped by the video encode policy circuit 1902 may be at least one of the input frames 101.

In a case where the video encoder circuit 304 shown in FIG. 3 or the video encoder circuit 906 shown in FIG. 9 is replaced by the encode-policy-aided video encoder circuit 1900, the activity indication INF_ACT received by the video encode policy circuit 1902 may be activity indication 301/901, and the at least one frame (e.g., IN_{N+1}) skipped by the video encode policy circuit 1902 may be at least one of the processed frames 103/707.

In a case where the video encoder circuit 1206 shown in FIG. 16 is replaced by the encode-policy-aided video encoder circuit 1900, the activity indication INF_ACT received by the video encode policy circuit 1902 may be post-processed activity indication 1504, and the at least one frame (e.g., IN_{N+1}) skipped by the video encode policy circuit 1902 may be at least one of the post-processed input frames 1603.

In a case where the video encoder circuit 906 shown in FIG. 15 is replaced by the encode-policy-aided video encoder circuit 1900, the activity indication INF_ACT received by the video encode policy circuit 1902 may be post-processed activity indication 1504, and the at least one frame (e.g., IN_{N+1}) skipped by the video encode policy circuit 1902 may be at least one of the post-processed frames 1405.

Furthermore, regarding the embodiments shown in FIGS. 9, 12, 15, and 16 that are modified to employ the encode-policy-aided video encoder circuit 1900, the content activity analyzer circuit 904 may or may not generate a new processed transformed frame when activity indication indicates that a frame that is received by the encode-policy-aided video encoder circuit 1900 and corresponds to the current frame should be skipped by the encode-policy-aided video encoder circuit 1900.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A video encoding apparatus comprising:
a content activity analyzer circuit, arranged to apply a content activity analysis process to a plurality of frames, and generate a plurality of content activity analysis results, wherein the plurality of frames are derived from a plurality of input frames of the video encoding apparatus; and
a video encoder circuit, arranged to perform a video encoding process to generate a bitstream output of the video encoding apparatus;
wherein at least one frame is not encoded into the bitstream output according to the plurality of content activity analysis results.

2. The video encoding apparatus of claim 1, wherein the content activity analyzer circuit is arranged to apply the content activity analysis process to a current frame according to the current frame and a previous frame, and skip generation of a processed frame in a content activity analysis result of the current frame according to similarity between the current frame and the previous frame, where the at least one frame not encoded into the bitstream output corresponds to the processed frame.

3. The video encoding apparatus of claim 2, wherein in response to the similarity between the current frame and the previous frame that indicates motion between the current frame and the previous frame is smaller than a threshold, the content activity analyzer circuit skips generation of the processed frame.

4. The video encoding apparatus of claim 2, wherein the plurality of frames received by the content activity analyzer circuit are the plurality of input frames of the video encoding apparatus, respectively.

5. The video encoding apparatus of claim 4, wherein the current frame is one of the plurality of input frames, and the previous frame is another of the plurality of input frames.

6. The video encoding apparatus of claim 4, wherein the current frame is one of the plurality of input frames, and the previous frame is a processed frame included in a content activity analysis result of another of the plurality of input frames.

7. The video encoding apparatus of claim 2, further comprising:
an image transformer circuit, arranged to apply an image transform process to the plurality of input frames of the video encoding apparatus, to generate a plurality of transformed frames as the plurality of frames received by the content activity analyzer circuit.

8. The video encoding apparatus of claim 7, wherein the current frame is one of the plurality of transformed frames, and the previous frame is another of the plurality of transformed frames.

9. The video encoding apparatus of claim 7, wherein the current frame is one of the plurality of transformed frames, and the previous frame is a processed transformed frame included in a content activity analysis result of another of the plurality of transformed frames.

10. The video encoding apparatus of claim 1, wherein the content activity analyzer circuit is arranged to apply the content activity analysis process to a current frame according to the current frame and a previous frame, and generate a content activity analysis result of the current frame; the content activity analysis result comprises activity indication indicative of similarity between the current frame and the previous frame; and the at least one frame not encoded into the bitstream output corresponds to the current frame.

11. The video encoding apparatus of claim 10, wherein in response to the similarity between the current frame and the previous frame that indicates motion between the current frame and the previous frame is smaller than a threshold, the at least one frame is not encoded into the bitstream output.

12. The video encoding apparatus of claim 10, wherein the video encoder circuit refers to the activity indication to skip encoding of the at least one frame received by the video encoder circuit.

13. The video encoding apparatus of claim 10, further comprising:
a video encode policy circuit, arranged to refer to the activity indication to block the at least one frame received by the video encode policy circuit from being sent to the video encoder circuit.

14. The video encoding apparatus of claim 10, wherein the at least one frame comprises at least one of the plurality of input frames of the video encoding apparatus.

15. The video encoding apparatus of claim 10, wherein the content activity analysis result further comprises a processed frame, and the at least one frame comprises the processed frame.

16. The video encoding apparatus of claim 10, further comprising:
a video processor circuit, arranged to apply post-processing to at least one of the plurality of input frames of the video encoding apparatus to generate at least one post-processed input frame, wherein the at least one frame not encoded into the bitstream output comprises the at least one post-processed input frame.

17. The video encoding apparatus of claim 10, wherein the content activity analysis result further comprises a processed frame, and the video encoding apparatus further comprises:
a video processor circuit, arranged to apply post-processing to the processed frame to generate a post-processed frame, wherein the at least one frame not encoded into the bitstream output comprises the post-processed frame.

18. The video encoding apparatus of claim 10, further comprising:
a video processor circuit, arranged to apply post-processing to the activity indication to generate post-processed activity indication, wherein the at least one frame is not encoded in the bitstream output according to the post-processed activity indication.

19. A video encoding method comprising:
applying a content activity analysis process to a plurality of frames, and generating a plurality of content activity analysis results, wherein the plurality of frames are derived from a plurality of input frames; and
performing a video encoding process to generate a bitstream output;
wherein at least one frame is not encoded into the bitstream output according to the plurality of content activity analysis results.

20. The video encoding method of claim 19, wherein the content activity analysis process is applied to a current frame according to the current frame and a previous frame, and generation of a processed frame in a content activity analysis result of the current frame is skipped according to similarity between the current frame and the previous frame, where the at least one frame not encoded into the bitstream output corresponds to the processed frame; or
wherein the content activity analysis process is applied to the current frame according to the current frame and the previous frame, and a content activity analysis result of the current frame is generated, where the content activity analysis result comprises activity indication indicative of similarity between the current frame and the previous frame, and the at least one frame not encoded into the bitstream output corresponds to the current frame.
